(19) United States
(12) Patent Application Publication
(10) Pub. No.: US 2023/0119332 A1
(43) Pub. Date: Apr. 20, 2023

(54) USB CONNECTOR FOR FIBER OPTIC CABLE AND RELATED USB EXTENDER

(71) Applicant: Celerity Technologies Inc., Irvine, CA (US)

(72) Inventor: Xiaolin TONG, Irvine, CA (US)

(73) Assignee: Celerity Technologies Inc., Irvine, CA (US)

(21) Appl. No.: 17/503,501

(22) Filed: Oct. 18, 2021

(51) Int. Cl. H01B 11/22; G02B 6/42; H04B 10/80; G06F 13/38

(52) U.S. Cl. CPC H01B 11/22; G02B 6/428; H04B 10/801; G06F 13/382; G06F 2213/3812; G06F 2213/3852

(57) ABSTRACT

A USB-C connector for a fiber optic cable has a two-section dongle form. The small plug section has a USB-C plug head and an optical transceiver and control circuitry, but no other signal processing functions. The second section includes a fiber connector and a signal processing chipset, but no optical transceiver. The two sections are connected together by a short hybrid cable containing both optical fibers and electrical wires. The optical fibers connect the optical transceiver to the fiber connector. A subset of electrical wires connect the control circuitry to the chipset, and another subset of electrical wires connect the chipset to a second subset of pins of the plug head. A first subset of pins of the plug head are connected directly to the control circuitry for optical-electrical signal conversion. Two such USB-C connectors connected to the ends of a long all-fiber cable form a USB-C extender.

### BACKGROUND OF THE INVENTION

### Field of the Invention

This invention relates to transmission of signals by fiber optic cables, and in particular, it relates to connectors between fiber optic cables and USB (Universal Serial Bus) ports, such as USB-C ports, and USB extenders employing such connectors.

### Description of Related Art

Due to their large bandwidth and long reach, fiber optic cables are widely used to transmit data. For example, fiber optic cables may be used to transmit video, audio and other signal between video sources (such as video players, video signal switches, computers, etc.) and display devices (such as digital televisions, monitors, etc.). On the other hand, electronic devices are typically equipped with ports for data communication, where the ports typically comply with various industry standards such as USB (Universal Serial Bus), HDMI (High Definition Multimedia Interface), DP (DisplayPort), DVI (Digital Visual Interface), VGA (Video Graphics Array), etc. Connectors between fiber optic cable and HDMI, DP, DVI, and Keystone ports have been available.

### SUMMARY

Embodiments of the present invention provide a USB-C connector for fiber optic cable. To overcome challenges arising from various requirements of the USB-C standard, the USB-C connector employs a two-section dongle form to ensure reliability and high performance.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a signal connector, which includes: a plug section, a dongle assembly, and a connection cable assembly connecting the plug section to the dongle assembly. The plug section includes a plug head having a first plurality of pins and a second plurality of pins, an optical transceiver configured to convert signals between electrical signals and optical signals, and control circuitry configured to control the optical transceiver, the control circuitry being electrically coupled to the first plurality of pins of the plug head. The dongle assembly includes an optical fiber connector and at least one signal processing chip. The connection cable assembly includes a first plurality and a second plurality of optical fibers connecting the optical transceiver of the plug section to the optical fiber connector of the dongle assembly, a first plurality of electrical conductor wires connecting the control circuitry of the plug section to the signal processing chip of the dongle assembly, and a second plurality of electrical conductor wires connecting the second plurality of pins of the plug head of the plug section to the signal processing chip of the dongle assembly. The at least one signal processing chip is configured to process electrical signals transmitted between the second plurality of pins of the plug head and the control circuitry.

In some embodiments, the plug head is a USB-C(Universal Serial Bus-C) plug head and has physical dimensions less than 12.35 mm in width and less than 6.5 mm in height. The first plurality of pins of the USB-C plug head are SuperSpeed signal pins and the second plurality of pins of the USB-C plug head are non-SuperSpeed signal pins. The control circuitry is configured to: control the optical transceiver to convert electrical signals received from the SuperSpeed signal pins of the USB-C plug head to optical signals to be transmitted to the first plurality of optical fibers; control the optical transceiver to convert optical signals received on the first plurality of optical fibers to electrical signals and to transmit the electrical signals to the SuperSpeed signal pins of the USB-C plug head; control the optical transceiver to convert electrical signals received from the signal processing chip via the first plurality of electrical conductor wires to optical signals to be transmitted to the second plurality of optical fibers; and control the optical transceiver to convert optical signals received on the second plurality of optical fibers to electrical signals and to transmit the electrical signals to the signal processing chip via the first plurality of electrical conductor wires.

In some embodiments, the signal processing chip is configured to perform signal multiplexing and demultiplexing and to control signal transmission directions on the optical fibers.

In some other embodiments, the plug head is a USB-A (Universal Serial Bus-A), miniDP (miniDisplayPort), HDMI (High Definition Multimedia Interface), DVI (Digital Visual Interface), or Thunderbolt plug head.

In another aspect, the present invention provides a signal extender, which includes the signal connector described above and a fiber optic cable connected to the signal connector. In some embodiments, another signal connector is connected to the other end of the fiber optic cable. The two connectors may comply with the same or different interface standards, such as USB-C or other standards. In some embodiments, the signal connectors and the fiber optic cable are connected to each other by MPO (Multi-fiber Push On) connectors.

In another aspect, the present invention provides a signal transmitter and receiver device, which includes an enclosure, and a first and a second printed circuit boards disposed within the enclosure. The first printed circuit board has an electrical signal connector, an optical transceiver, and control circuitry mounted on it, wherein the electrical signal connector has a first plurality of pins and a second plurality of pins, the optical transceiver is configured to converts between electrical signals and optical signals, the control circuitry is configured to control the optical transceiver, and the control circuitry is electrically coupled to the first plurality of pins of the electrical signal connector. The second printed circuit board has at least one signal processing chip mounted on it. A bus electrically connects the first and second printed circuit boards, and includes a first plurality of electrical conductors connecting the control circuitry on the first printed circuit board to the signal processing chip on the second printed circuit board, and a second plurality of electrical conductors connecting the second plurality of pins of the electrical signal connector on the first printed circuit board to the signal processing chip on the second printed circuit board. An optical fiber connector is also mounted within the enclosure. A plurality of optical fibers are disposed within the enclosure and connect the optical transceiver on the first printed circuit board to the optical fiber connector. The at least one signal processing chip is configured to process electrical signals transmitted between the second plurality of pins of the electrical signal connector on the first printed circuit board and the control circuitry.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a USB-C connector for a fiber optic cable according to an embodiment of the present invention.

FIG. 1A schematically illustrates a USB-A connector for a fiber optic cable according to another embodiment of the present invention.

FIGS. 1B and 1C schematically illustrates a USB-C connector for a fiber optic cable according to alternative embodiments of the present invention.

FIG. 2 is a block diagram that further illustrates the structure of the USB-C connector of FIG. 1.

FIG. 3 schematically illustrates a fiber optic USB-C extender formed by a fiber optic cable with two USB-C connectors at the two ends, at least one of the USB-C connectors being the connector of FIG. 1.

FIG. 4 schematically illustrates a signal transmitter and receiver device used in a stack-up configuration according to another embodiment of the present invention.

### DETAILED DESCRIPTION OF PREFERRED EMBODIMENTS

USB-C Connector

As the current data rates for USB-C and USB 4 signals are above 10 Gbps, copper cables are not able to support transmission distances longer than about 15 feet. Transmission by fiber optic cable often thus becomes highly desirable for longer distances. Therefore, there is a need to provide USB-C connectors that can connect fiber optic transmission cables to USB-C ports on electronic devices. Such a connector includes an optical transceiver that converts signals between electrical signals and optical signals, and digital signal processing chips that process the signal being transmitted. However, USB-C connector plug (the male connector) has a physical dimension requirement of 12.35 mm in maximum width and 6.5 mm in maximum height (width are height are dimensions perpendicular to the longitudinal direction of the plug). Due to this small physical size, issues arise that hinder the implementation of signal processing chips inside the plug. For example, the signal processing chips may be too large to fit inside the plug. Also, heat generated by the signal processing chips may heat up the plug, which may reduce the performance of the optical transceiver components inside the plug, in particular, the lasers.

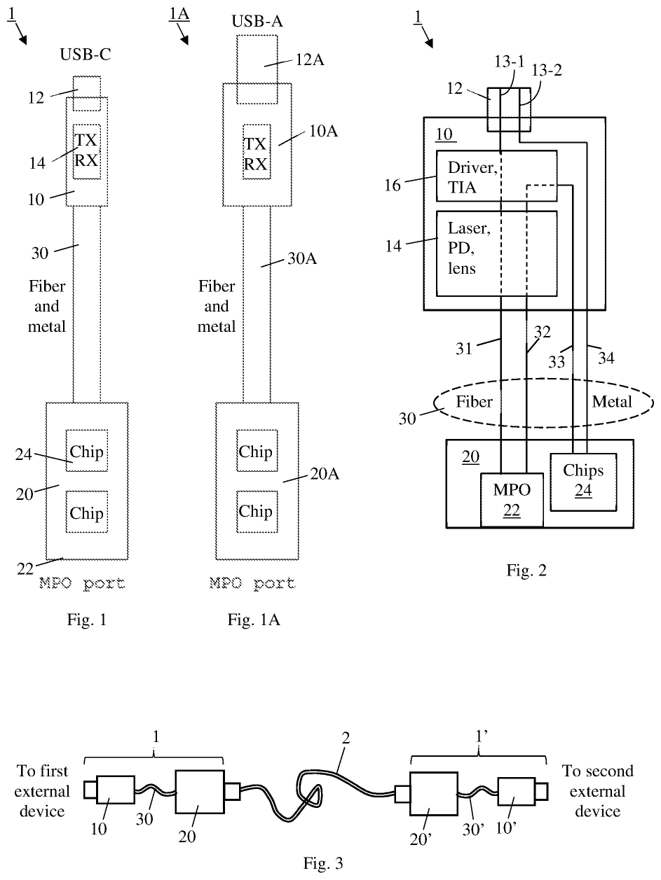

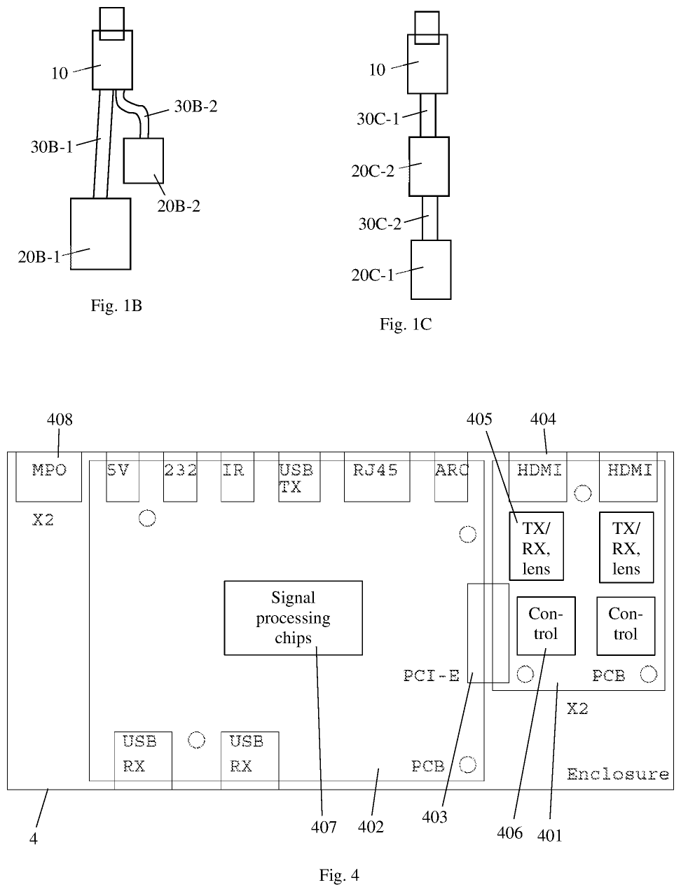

To solve these problems, embodiments of the present invention provide a USB-C connector for fiber optic cable that employs a two-section dongle form, with the signal processing chips being located in the second section of the dongle. For convenience, in this disclosure, the second section is referred to as the dongle section and the first section is referred to as the plug section. As shown in FIG. 1, the USB-C connector 1 according to embodiments of the present invention includes a plug section 10, a dongle section 20, and a short cable 30 connecting the plug section and the dongle section. The cable 30 is a hybrid cable that contains both optical fibers and conductor wires (e.g. copper or other metal wires).

The plug section 10 has a USB-C plug head 12 at the first end of the connector 1, configured to be inserted into a USB-C port of a first external device such as a USB host (see FIG. 3), and contains an optical transceiver 14. The physical dimensions of the plug section 10 comply with the USB-C requirements, i.e., less than or equal to 12.35 mm in width and less than or equal to 6.5 mm in height. The length is not limited, but preferably less than 25 mm. The dongle section 20 has an optical fiber connector 22, such as an MPO connector (Multi-fiber Push On connector, an industry-standard optical ribbon fiber connector for connecting to fiber optic cables), at the second end of the connector 1, and contains one or more signal processing chips 24. The fiber connector 22 is configured to be connected to an external fiber optic cable 2 which is ultimately (e.g. via another connector) connected to a second external device such as a USB device (see FIG. 3). There is no limit on the physical dimensions of the dongle section 20, as long as it can accommodate the fiber connector (e.g. MPO connector) and the chips inside. In some embodiments, the size of the dongle section 20 is within the range of 12 mm to 20 mm in width, 10 mm to 18 mm in height, and 25 mm to 40 mm in length. The length of the cable 30 is preferably a few inches, but any suitable length may be used, from one inch up to a few feet (e.g. 5 feet).

Each of the plug section 10, the dongle section 20 and the cable 30 has an enclosure (i.e. a plastic housing or cover) that encloses the internal components. Preferably, the cable 30 is formed integrally with the plug section 10 and dongle section 20, i.e. they are joined to each other permanently and cannot be separated during normal use.

The structure of the USB-C connector 1 is schematically illustrated in more detail in FIG. 2. The optical transceiver 14 within the plug section 10 includes an array of light emitters, such as VCSELs (vertical-cavity surface-emitting laser) or other types of lasers, and an array of light detectors, such as photodiodes, as well as optical coupling elements such as a lens array, preferably integrated into one component. The optical transceiver 14 is optically coupled to the fiber ends of an array of optical fibers 31, 32 from the cable 30. The other end of the optical fibers 31, 32 are directly coupled to the fiber connector 22 of the dongle section 20. Note that in FIGS. 2, each line 31, 32 represents a group of one or more optical fibers.

The plug section 10 further includes control circuitry 16 which includes, for example, a driver circuit for controlling the light emitters and a transimpedance amplifier (TIA) for amplifying electrical signals generated by the light detectors. The driver circuit and transimpedance amplifier are respectively coupled to the light emitters and light detectors by electrical connections. The control circuitry 16 is electrically coupled to a first group of pins 13-1 of the USB-C plug head 12. The control circuitry 16 is also electrically coupled to the signal processing chips 24 in the dongle section 20 by a first group of electrical conductor wires 33 of the cable 30. The signal processing chips 24 are directly electrically coupled to a second group of pins 13-2 of the USB-C plug head 12 by a second group of electrical conductor wires 34 of the cable 30. Note that in FIGS. 2, each line 33, 34 represents a group of one or more wires.

In preferred embodiments, the dongle section 20 contains no optical-electrical conversion components, and the plug section 10 contains no digital signal processing components (here, digital signal processing is understood to refer to manipulation of digital signals in the digital form; the functions of the driver and TIA are not digital signal processing). In some embodiments, the dongle section 20 may include a power supply connector (not shown) to receive an external power supply to allow power injection if desired. In preferred embodiments, the dongle section 20 has no other signal connection besides the fiber connector 22, the cable 30, and the optional power supply.

A standard USB-C interface, with a 24-pin double-sided layout, includes four SuperSpeed differential pairs TX1+, TX1−, RX1+, RX1−, TX2+, TX2−, RX2+, RX2−. In applications, the SuperSpeed signals may be used to transmit video signals or other data. In the plug section 10, the control circuitry 16 is directly coupled to the SuperSpeed pins of the USB-C plug head 12, which are indicated by reference symbol 13-1 in FIG. 2. The SuperSpeed signals on pins 13-1 are converted to/from optical signals by the optical transceiver 14 under control of the control circuitry 16, without further signal processing. The optical signal corresponding to the SuperSpeed signals are carried on the first group of optical fibers 31 (preferably four fibers).

More specifically, in the transmitting direction, the SuperSpeed electrical signals received from the first external device on pins 13-1 are fed to the driver circuit of the control circuitry 16, which drives the light emitters accordingly to generate optical signals on the first group of optical fibers 31. The optical signals on optical fibers 31 are coupled to the external fiber optic cable 2 by the fiber connector 22. In the receiving direction, the SuperSpeed optical signals on the first group of optical fibers 31 received via external cable 2 are converted to electrical signals by the light detectors of the optical transceiver 14 and amplified by the TIA of the control circuitry 16, and directly fed to the SuperSpeed pins 13-1 of the USB-C plug head 12.

The standard USB-C interface also includes various high speed (less than 1.5 Gbps) pins and other signal pins including the power wire. For convenience, these signals are collectively referred to as the non-SuperSpeed signals in this disclosure, and the corresponding pins of the USB-C plug head 12 are indicated by reference symbol 13-2. These non-SuperSpeed signals need to be processed between the pins 13-2 and the control circuitry 16. In embodiments of the present invention, the signal processing is performed by the chips 24 located in the dongle section 20, and routed between the plug section 10 and the dongle section 20 by the conductor wires 33 and 34 of the cable 30.

More specifically, in the transmitting direction, the non-SuperSpeed signals received on pins 13-2 are transmitted directly to the chips 24 of the dongle section 20 by the second group of conductor wires 34. Preferably, the second group of conductor wires 34 include sufficient number of wires to separately connect each one of the pins 13-2 to the signal processing chips 24. The signals are processed by the chips 24, and the processed signals are transmitted from the chips to the control circuitry 16 of the plug section 10 by the first group of conductor wires 33 of the cable 30. The driver in the control circuitry 16 drives the light emitters accordingly to generate optical signals on the second group of optical fibers 32. The optical signals on optical fibers 32 are coupled to the external fiber optic cable 2 by the fiber connector 22. In the receiving direction, after the optical signals on the second group of optical fibers 32 are converted to electrical signals by the light detectors of the optical transceiver 14 and amplified by the TIA of the control circuitry 16, the control circuitry sends the electrical signals to the signal processing chips 24 of the dongle section 20 via the first group of conductor wires 33. The signal processing chips 24 processes the signals, and transmits the resulting processed signals directly to the second group of pins 13-2 of the USB-C plug head 12 via the second group of conductor wires 34 of the cable 30.

Preferably, there is a one-to-one correspondence between the first group of conductor wires 33 and the second group of optical fibers 32, so that the plug section 10 can directly perform the optical-electrical and electrical-optical conversions for signals on each conductor wire 33 and corresponding optical fiber 32 without further signal processing (e.g. without signal multiplexing and demultiplexing). If the conductor wires 33 use pairs of differential wires, then there is preferably a one-to-one correspondence between the pairs of conductor wires 33 and the optical fibers 32

It can be seen from the above descriptions that in the USB-C connector 1 according to embodiments of the present invention, the SuperSpeed signals are directly converted to and from optical signals, without being transmitted as electrical signals over a conductor wire of the cable 30. This avoids potential signal degradation by the conductor wire, especially when the SuperSpeed signal speed is further increased from the current speed (5 Gbps) to 20 Gbps or higher in future standards. The further speed increase of the SuperSpeed signal will not change the working principle of the USB-C connector 1 described here. As to the high speed signals and other non-SuperSpeed signals, they can be properly transmitted between the plug section 10 and the dongle section 20 over the conductor wires 33, 34 of the cable 30 without degradation.

The processing of the non-SuperSpeed signals by the signal processing chips 24 includes one or more of the following.

Signal multiplexing and demultiplexing: In the USB-C connector 1, signals on all of the non-SuperSpeed pins 13-2 are multiplexed onto a few (e.g., two to four) optical fibers 32 for transmission over the external fiber optic cable 2 to the remote end. This is possible because of the higher bandwidth of the optical fibers. In the receiving direction, the optical signals on the second group of optical fibers 32, which are multiplexed signals that have been generated (for example by a USB-C connector 1′) at the remote end (see FIG. 3), are demultiplexed into the multiple USB-C signals to be coupled to the non-SuperSpeed pins 13-2 of the USB-C plug head 12. The multiplexing and demultiplexing are performed by the signal processing chips 24. Thus, the signals on the second group of optical fibers 32 and the first group of conductor wires 33 are multiplexed USB-C signals, and the signals on the second group of conductor wires 34 are demultiplexed USB-C signals.

Regulation of bus utilization (i.e. TX/RX directionality): USB-C standard permits bi-directional data transmission. For example, the D+, D− signal may be bi-directional. Because each optical fiber can transmit signals only in one direction at any given time, the two USB-C connectors 1, 1′ at the two ends of the external fiber optic cable 2 use one of the USB-C signals, such as the Configuration Channel (CC) signal, to dynamically set the transmission direction on each optical fiber. The signal processing chips 24 processes the Configuration Channel signal to set or obtain information regarding the transmission directions on each of the optical fibers. Based on this information, the signal processing chips 24 transmits control commands to the control circuitry 16 of the plug section 10 via a conductor wire of the cable 30, for example one of the first group of conductor wires 33 or a separate conductor wire, to instruct the control circuitry 16 to either transmit or receive signals on each optical fiber.

The signal processing chips 24 may also performs other desired signal processing functions.

The signal processing chips 24 may require an additional power supply to support their power up operation. In a situation where two devices are connected with a metal-wire cable, when the two devices are turned on, the metal wires between the devices will pass signals instantly. In a signal connector such as the USB-C connector 1 shown in FIGS. 1 and 2, however, because the signal processing chips 24 in the dongle section 20 require working power, they need to be powered up before the cable can pass signals. During a power up process, the chips may need to go through a long list of initializations before normal working condition or status is established. In some applications, there are frequent power on/off cycles, so the initialization time becomes an issue. Therefore, it is desirable to keep the signal processing chips 24 powered on to avoid frequent power on/off cycles. In embodiments of the present invention, two alternative techniques may be used to solve this problem. In the first technique, an extra power source that is not related to the equipment power on/off cycles is provided to the dongle section 20. A disadvantage of this technique is that it requires an external power source. In the second technique, a small battery that supplies power to the chipset for an short length of time (e.g., about 30 seconds) during power off is provided in the dongle section 20 to keep the components powered during frequent power on/off cycles. This prevents interruption during power on/off cycles. The battery may be charged by the USB power line when the USB power is on. It should be noted that the optical transceiver and its control circuitry typically have a fast response time at power on and therefore does not need to be powered by the extra small battery. Only chips that have longer initialization times will be powered by the extra small battery. In this respect, this technique is different from powering up the whole dongle.

Although the USB-C connector 1 shown in FIGS. 1 and 2 has a two-section dongle form, a three-section dongle form may alternatively be used (even though it may be less convenient), where the fiber connector 22 and the signal processing chips 24 are located within two separate dongle sections. The three sections may have a Y configuration (see FIG. 1B), with a first dongle section 20B-1 (containing fiber connector 22) connected to the plug section 10 by a short fiber optic cable 30B-1 and a second dongle section 20B-2 (containing signal processing chips 24) connected to the plug section 10 by a short electrical cable 30B-2. Or, the three sections may have a string configuration (see FIG. 1C), where the second dongle section 20C-2 (containing signal processing chips 24) is located between the plug section 10 and the first dongle section 20C-1 (containing fiber connector 22), the three sections being connected into a string by a short hybrid cable 30C-1 between the plug section 10 and the second dongle section 20C-2 and a short fiber cable 30C-2 between the second dongle section 20C-2 and the first dongle section 20C-1. For purpose of this disclosure, in the three-section configurations, the two dongle sections are collectively referred to as a dongle assembly, and the cable or cables connecting the plug section to the dongle assembly are collectively referred to as a connection cable assembly.

To summarize, embodiments of the present invention provide a USB-C connectors employing a multi-section dongle form, where the plug section contains only the optical transceiver and its control circuit to perform optical-electrical signal conversion without other signal processing chips, and the dongle assembly (one or two dongle sections) contains the signal processing chips and fiber connector but no optical transceiver. The dongle assembly is connected to the plug section by a suitable connection cable assembly (one or two cables).

The structures of the multi-section dongle form connector 1 described here may be used to implement other connectors such as USB-A connectors, miniDP connectors, HDMI connectors, Thunderbolt connectors, etc. A USB-A connector 1A is illustrated as an example in FIG. 1A, where the plug head 12A is a USB-A plug. The signal processing functions performed by the chips in the dongle section 20A may be different from that of the USB-C connector 1, but the structure is otherwise similar to the USB-C connector 1. Note that although a USB-A plug has fewer lines and a larger allowed physical size than a USB-C plug, making it possible to implement a USB-A connector with the signal processing chips located in the plug section (i.e. a single section form), it may nevertheless be advantageous to use a multi-section dongle form and place the signal processing chips in the dongle section. The same applies to the other connectors. In a DP or HDMI or other connectors, 5G or higher data rate signals may be directed converted between electrical and optical and transmitted on their own fibers without multiplexing, and 1G or lower data rate signals may be multiplexed into one or more fibers for each direction.

USB-C Extender, Other Extenders and Adapters

The configuration shown in FIG. 3, where the external fiber optic cable 2 (preferably an all-fiber cable, containing no electrical conductor wires) has two USB-C connectors 1, 1′ connected to its two ends, forms a fiber optic USB-C extender. The other USB-C connector 1′ may have a structure either identical to or different from the USB-C connector 1, so long as the two USB-C connectors 1, 1′ cooperate with each other to correctly perform signal multiplexing/demultiplexing (using any suitable multiplexing scheme), directionality regulation, and other signal processing functions.

This USB-C extender is transparent, in that it transmits signals between the two ends without storing any data, and it does not interpret the meaning of the data being transmitted.

In an alternative embodiment, the other USB-C connector 1′ may have a USB-C receptacle (female connector), rather than a USB-C plug (male connector), at its end. In this alternative structure, the connector 1′ may have a two-section dongle form, or a one-section form if its physical size can accommodate the signal processing chips without adversely affecting the performance of the optical transceiver.

In an alternative to the configuration shown in FIG. 3, the connector 1′ at the other end of the fiber optic cable 2 may be one that complies with another industry standard such as HDMI (or DVI, miniDP, USB-A, etc.) (either single-section or multi-section dongle form), and have appropriate signal conversion functions, in which case the overall configuration forms a fiber optic USB-C to HDMI (or DVI, miniDP, USB-A, etc.) adapter. Such an adapter may be used to connect a host computer with a USB-C port to a projector with an HDMI port (or a monitor with miniDP port, or a storage device with a USB-A port, etc.).

In the fiber optic USB-C extender shown in FIG. 3, the fiber optic cable 2 has two fiber connectors (e.g. MPO male connectors) at its two ends configured to be plugged into the fiber connector 22 of the USB-C connectors 1 and 1′. In alternative embodiments, the fiber optic cable 2 may be formed integrally with either the USB-C connector 1, or the USB-C connector 1′, or both, without using fiber connectors. In such cases, the optical fibers 31, 32 in the cable 2 pass directly through the dongle section 20 to the cable 30.

As pointed out above, because of the much higher bandwidth of the optical fibers, a small number, such as two to four, optical fibers can carry all of the non-SuperSpeed USB-C signals in a multiplexed manner. Thus, the cable 30 and the external fiber optic cable 2 may each include six to eight optical fibers in total. The external fiber optic cable 2 may alternatively have a different number of optical fibers as the cable 30.

To summarize, the fiber optic USB-C extender shown in FIG. 3 can transmit USB-C signals using a fiber optic cable having six to eight optical fibers, by transmitting the SuperSpeed signals on four optical fibers and multiplexing the non-SuperSpeed signals onto two to four optical fibers. Due to physical dimension requirements of the USB-C plug head, the USB-C connector is designed to have a multi-section dongle form, where the signal processing chips that handle data multiplexing, directionality regulation, etc. is located in the dongle section that is connected to the plug head section by a short cable.

More generally, embodiments of the present invention provide a fiber optic signal extender or adapter, formed by a fiber optic cable of an extended length (e.g. tens or hundreds of feet) and two electrical signal connectors at each end, the two connectors preferably complying with industry standards (same or different at the two ends), where at least one of the two connectors has a multi-section dongle form described above.

Stack-Up Modules

The optical and electrical signal handling and routing scheme used in the USB-C connector 1 can be applied to signal transmitters and receivers of other physical form factors to provide various benefits. One example is a signal transmitter and receiver device suitable for use in a stack-up configuration, shown in FIG. 4. Such a device may be used with an electronic device such as a video source or a display device to provide fiber optic connections. As shown in FIG. 4, the signal transmitter and receiver device 4 has two separate printed circuit boards (PCBs) 401 and 402, electrically coupled to each other by a bus 403 such as a PCI-e (Peripheral Component Interconnect Express) bus. The first, smaller PCB 401 has functions similar to the plug section 10 of the USB-C connector 1 of FIGS. 1 and 2, and the second, main PCB 402 has functions similar to the dongle section 20 of the USB-C connector 1.

More specifically, the first PCB 401 supports one or more sets of an electrical signal connector 404 (e.g. an HDMI port), a corresponding optical transceiver 405 (including optical coupling components), and corresponding control circuitry 406. The second PCB 402 supports signal processing chips 407, as well as various other electrical signal connectors such as RS-323, IR, USB, RJ45, ARC (Audio Return Channel), and power supply connector. The electrical connections among these components are omitted in FIG. 4 to avoid overcrowding. The device 4 also has one or more optical fiber connectors 408 (e.g. MPO connectors), coupled to the optical transceiver 405 by optical fibers (not shown) which are disposed within the enclosure of the transmitter and receiver device.

In terms of their functions, the electrical signal connector 404 is similar to the USB-C plug head 12 of the USB-C connector 1, the optical transceiver 405 is similar to the optical transceiver 14, the control circuitry 406 is similar to the control circuitry 16, the signal processing chips 407 are similar to the signal processing chips 24, the fiber connector 408 is similar to the fiber connector 22, the bus 403 is similar to the conductor wires 33, 34, and the optical fibers between the optical transceiver 405 and fiber connector 408 are similar to the optical fibers 31, 32. The optical and electrical signal routing among the various components is also similar to that in the USB-C connector 1. Therefore, further descriptions are omitted. Of course, the signal processing chips 407 may also perform other signal processing functions related to the other signals handled by the device 4.

Using the configuration shown in FIG. 4, the optical transceiver 405 (and control circuitry 406) can be located relatively close to the electrical signal connector 404, while the signal processing chips 407 can be located relatively far away from the electrical signal connector. Keeping the high speed data optical link near the electrical signal connector improves the signal to noise ratio. By using two separate PCBs, the first, smaller PCB 401 only handles the optical-electrical conversion for the high speed data link, without experiencing the noise level that the second, main PCB 402 may experience due to the presence of other components.

Locating the fiber connector (MPO) 408 at one end of the device 4 may facilitate easy plug and pull of the external fiber cable, and also saves PCB real estate (the fiber connector is not mounted on the main PCB). The smaller PCB 401 may be advantageously located at the other end of the device 4 to allow sufficient space inside the enclosure for the fiber between the electrical signal connector 404 and fiber connector (MPO) 408 to bend.

While two HDMI ports are shown in the example of FIG. 4, the electrical signal connectors 404 may be other connectors or ports such as DP, USB-A, USB-C or combinations thereof. Further, while two electrical signal connectors 404 are shown in FIG. 4, other numbers (three, four, etc.) are possible. In alternative embodiments, two or more smaller PCBs 401 may be provided side-by-side, each with one or more electrical signal connectors 404, optical transceivers 405 and control circuitry 406. The multiple smaller PCBs and the main PCB 402 may be electrically connected to each other by PCI-e and/or ribbon cable connections.

Dongle Form for Wireless Chipsets

The two-section dongle form may be used in other pluggable devices. For example, some pluggable devices include wireless chipsets for wireless communication. Sometimes, for various reasons, it is undesirable for the wireless chipsets to be physically located close to the computer or other instrument that the pluggable device is plugged into. In such cases, the pluggable device may use a two-section dongle form, with the wireless chipsets located in the dongle section and physically separated from the plug section by a small distance, so that both sections can function properly. This configuration may be used in USB-C, DP, HDMI, etc. connectors, or any other pluggable devices. Note that such pluggable devices are not limited to optical fiber related applications, but have general applicability.

It will be apparent to those skilled in the art that various modification and variations can be made in the USB-C connector, USB-C extender, other extenders, adapters, and stack up modules of the present invention without departing from the spirit or scope of the invention. Thus, it is intended that the present invention cover modifications and variations that come within the scope of the appended claims and their equivalents.

What is claimed is:

1. A signal connector, comprising:
a plug section, which includes a plug head having a first plurality of pins and a second plurality of pins, an optical transceiver configured to convert signals between electrical signals and optical signals, and control circuitry configured to control the optical transceiver, the control circuitry being electrically coupled to the first plurality of pins of the plug head;
a dongle assembly, which includes an optical fiber connector and at least one signal processing chip; and
a connection cable assembly connecting the plug section to the dongle assembly, including a first plurality and a second plurality of optical fibers connecting the optical transceiver of the plug section to the optical fiber connector of the dongle assembly, a first plurality of electrical conductor wires connecting the control circuitry of the plug section to the signal processing chip of the dongle assembly, and a second plurality of electrical conductor wires connecting the second plurality of pins of the plug head of the plug section to the signal processing chip of the dongle assembly, and
wherein the at least one signal processing chip is configured to process electrical signals transmitted between the second plurality of pins of the plug head and the control circuitry.

2. The connector of claim 1, wherein the plug head is a USB-C(Universal Serial Bus-C) plug head.

3. The signal connector of claim 2, wherein the plug section has physical dimensions less than 12.35 mm in width and less than 6.5 mm in height.

4. The signal connector of claim 2, wherein the first plurality of pins of the USB-C plug head are SuperSpeed signal pins and the second plurality of pins of the USB-C plug head are non-SuperSpeed signal pins.

5. The signal connector of claim 4, wherein the control circuitry is configured to:
control the optical transceiver to convert electrical signals received from the SuperSpeed signal pins of the USB-C plug head to optical signals to be transmitted to the first plurality of optical fibers;
control the optical transceiver to convert optical signals received on the first plurality of optical fibers to electrical signals and to transmit the electrical signals to the SuperSpeed signal pins of the USB-C plug head;
control the optical transceiver to convert electrical signals received from the signal processing chip via the first plurality of electrical conductor wires to optical signals to be transmitted to the second plurality of optical fibers; and
control the optical transceiver to convert optical signals received on the second plurality of optical fibers to electrical signals and to transmit the electrical signals to the signal processing chip via the first plurality of electrical conductor wires.

6. The signal connector of claim 5, wherein the at least one signal processing chip is configured to:
multiplex electrical signals receive from one or more of the non-SuperSpeed signal pins of the USB-C plug head via the second plurality of electrical conductor wires, and transmit the multiplexed signals to the control circuitry of the plug section via the first plurality of electrical conductor wires; and
demultiplex electrical signals received from the control circuitry via the first plurality of electrical conductor wires, and transmit the demultiplexed signals to one or more of the non-SuperSpeed signal pins of the USB-C plug head via the second plurality of electrical conductor wires.

7. The signal connector of claim 6, wherein the at least one signal processing chip is further configured to:
set signal transmission directions on the first and second plurality of optical fibers, and process signals received from the control circuitry to obtain information regarding signal transmission directions on the first and second plurality of optical fibers; and
transmit commands regarding the transmission directions to the control circuitry;
wherein the control circuitry controls the optical transceiver to transmit or receive optical signals on the first and second plurality of optical fibers based on the commands regarding the transmission directions.

8. The signal connector of claim 1, wherein the plug section performs no digital signal processing functions and the dongle assembly performs no conversion between electrical signals and optical signals.

9. The signal connector of claim 1, wherein the dongle assembly includes a single enclosure that encloses both the optical fiber connector and the at least one signal processing chip, and the connection cable assembly is a single cable with an enclosure that encloses both the first and second pluralities of optical fibers and the first and second pluralities of electrical conductor wires.

10. The signal connector of claim 9, wherein the cable has a length of from one inch to five feet.

11. The signal connector of claim 1, wherein the dongle assembly further includes either a power supply connector configured to receive an external power supply, or a battery, configured to supply power to the at least one signal processing chip.

12. The signal connector of claim 1, wherein dongle assembly includes a first dongle section containing the optical fiber connector and a separate second dongle section containing the at least one signal processing chip, wherein the plug section and the first and second dongle sections are connected by the connection cable assembly in a Y configuration or a string configuration.

13. The connector of claim 1, wherein the plug head is a USB-A (Universal Serial Bus-A) plug head, or a miniDP (miniDisplayPort) plug head, or a HDMI (High Definition Multimedia Interface) plug head, or a DVI (Digital Visual Interface) plug head, or a Thunderbolt plug head.

14. A signal extender, comprising:
a signal connector of claim 1; and
a fiber optic cable having a second optical fiber connector at a first end which is connected to the optical fiber connector of the signal connector.

15. The signal extender of claim 14, wherein the fiber optic cable has a third optical fiber connector at a second end,
the signal extender further comprising a second signal connector having a fourth optical fiber connector and a second plug section with a second plug head,
wherein the third optical fiber connector at the second end of the fiber optic cable is connected to the fourth optical fiber connector of the second signal connector.

16. The signal extender of claim 14, wherein the optical fiber connector, the second optical fiber connector, the third optical fiber connector and the fourth optical fiber connectors are MPO (Multi-fiber Push On) connectors.

17. The signal extender of claim 14, wherein the plug head of the signal connector is a USB-C (Universal Serial Bus-C) plug head and the second plug head of the second signal connector is a USB-C plug head.

18. The signal extender of claim 14, wherein the plug head of the signal connector is a USB-C (Universal Serial Bus-C) plug head and the second plug head of the second signal connector is a USB-A (Universal Serial Bus-A) plug head, or a miniDP (miniDisplayPort) plug head, or a HDMI (High Definition Multimedia Interface) plug head, or a DVI (Digital Visual Interface) plug head, or a Thunderbolt plug head.

19. A signal transmitter and receiver device, comprising:
an enclosure;
a first printed circuit board disposed within the enclosure;
an electrical signal connector, an optical transceiver, and control circuitry mounted on the first printed circuit board, wherein the electrical signal connector has a first plurality of pins and a second plurality of pins, the optical transceiver is configured to converts between electrical signals and optical signals, the control circuitry is configured to control the optical transceiver, and the control circuitry is electrically coupled to the first plurality of pins of the electrical signal connector;
a second printed circuit board disposed within the enclosure;
at least one signal processing chip mounted on the second printed circuit board;
a bus electrically connecting the first and second printed circuit boards, including a first plurality of electrical conductors connecting the control circuitry on the first printed circuit board to the signal processing chip on the second printed circuit board, and a second plurality of electrical conductors connecting the second plurality of pins of the electrical signal connector on the first printed circuit board to the signal processing chip on the second printed circuit board;
an optical fiber connector mounted within the enclosure; and
a plurality of optical fibers disposed within the enclosure and connecting the optical transceiver on the first printed circuit board to the optical fiber connector,
wherein the at least one signal processing chip is configured to process electrical signals transmitted between the second plurality of pins of the electrical signal connector and the control circuitry on the first printed circuit board.

20. The signal transmitter and receiver device of claim 19, wherein the optical fiber connector is an MPO connector, and wherein the electrical signal connector is one of an HDMI connector, a DP (DisplayPort) connector, a miniDP (miniDisplayPort) connector, a DVI (Digital Visual Interface) connector, a USB-A (Universal Serial Bus-A) connector, a USB-C(Universal Serial Bus-C) connector, and a Thunderbolt connector.
